(19) United States
(12) Patent Application Publication
(10) Pub. No.: US 2010/0062293 A1
(43) Pub. Date: Mar. 11, 2010

(54) INTERNAL REFORMING ALCOHOL HIGH TEMPERATURE PEM FUEL CELL

(75) Inventors: Nikolaos Triantafyllopoulos, Patras (GR); Maria Geormezi, (US); Ioanna Papavasiliou, Patras (GR); Maria Daletou, Patras (GR); Joannis Kallitsis, Patras (GR); Stylianos Neophytides, Patras (GR); Theophilos Ioannides, Patras (GR); George Avgouropoulos, Achaias (GR)

Correspondence Address: Saul Ewing LLP (Baltimore);Attn: Patent Docket Clerk, Lockwood Place, 500 East Pratt Street, Suite 900, Baltimore, MD, 21202, US

(73) Assignee: ADVENT TECHNOLOGIES, ATHENS (GR)

(21) Appl. No.: 12/556,622

(22) Filed: Sep. 10, 2009

Related U.S. Application Data
(60) Provisional application No. 61/095,779, filed on Sep. 10, 2008.

(51) Int. Cl. H01M 8/04; H01M 8/18

(52) U.S. Cl. 429/17; 429/19

(57) ABSTRACT

This invention refers to an Internal Reforming Alcohol Fuel Cell (IRAFC) using polymer electrolyte membranes (PEMs), which are functional at 190-220° C. and alcohol fuel reforming catalysts for the production of CO-free hydrogen in the temperature range of high temperature PEM fuel cell. The fuel cell comprises: an anode; a high-temperature ion-conducting electrolyte membrane, and any other polymer electrolyte that can operate at temperatures between about 180° C. to about 230° C.; a cathode and two current collectors on each side of the cell.

### FIELD

This invention refers to an Internal Reforming Alcohol Fuel Cell (IRAFC) composed of a membrane electrode assembly (MEA) comprising a high-temperature proton-conducting electrolyte membrane sandwiched between the anodic, fuel reforming catalyst for the production of CO-free hydrogen+anode electrocatalyst, and cathodic gas diffusion electrodes.

### BACKGROUND

Among the various types of fuel cells, Polymer Electrolyte Membrane Fuel Cells (PEMFCs), which typically consume H₂ and O₂, operating at 80-100° C. producing electricity without polluting the environment, seem to be the most technically advanced energy conversion system for stationary and mobile applications and have the highest potential for market penetration. However, the use of pure H₂, especially for mobile applications, is hindered by problems of storage, safety and refueling.

Alcohol fuels such as methanol or ethanol have the benefits of having volume energy densities five- to seven-fold greater than that of standard compressed H₂, being easily handled, stored and transported, being almost sulphur-free and are reformed at moderate temperatures (200-300° C.) with low selectivity to byproducts (e.g. CO). Moreover, methanol or ethanol can be produced from renewable sources (e.g. biomass), and as a consequence, may be considered as a sustainable energy carrier which would contribute to net-zero carbon dioxide (CO₂) emissions.

The production of H₂-rich gas streams for PEMFCs systems can be done in a fuel processor unit by reforming an alcohol or a hydrocarbon liquid fuel. The resulting gas mixture contains significant amounts of CO and it is further processed with additional steam in a WGS reactor. The latter step can be avoided by using methanol as a starting fuel. In any case the obtained gas mixture contains: 45-75% H₂, 15-25% CO₂, 0.5-2% CO, a few % H₂O and N₂. An additional step of CO removal is required in order to protect the anode electrocatalyst, thus complicating further the balance of plant of the fuel processor.

Hydrogen can be catalytically produced from methanol via endothermic steam reforming (SRM) at relatively low temperatures (200-300° C.) with high selectivity. In the case of the Internal Reforming Alcohol PEM fuel cell system, the required heat for the SRM process is supplied by the fuel cell itself. Commercially available copper-based catalysts, typically with composition Cu—ZnO—(Al₂O₃) have been widely used for generating hydrogen from methanol. Even though these catalysts are widely used in H₂ plants, several drawbacks limit their application in small stationary or mobile fuel processors: (a) slow start-up response due to the slow kinetics, (b) pyrophoricity of reduced catalysts, (c) poor thermal stability above 300° C. due to agglomeration of copper, (d) irreversible deactivation if exposed to liquid water formed during shutdown. Especially, the pyrophoric behaviour of conventional SRM catalysts has to be controlled when reduced Cu is abruptly exposed to air after turning off the feed of reactants, since major local temperature spikes can occur due to fast copper oxidation, which may lead to sintering and deactivation of Cu particles. The application of alternative Cu—Mn prepared by a combustion method in methanol reforming has been reported [see J. Papavasiliou, G. Avgouropoulos, T. Ioannides, J. Catal. 251 (2007) 7, herein incorporated by reference]. It was found that despite their low surface areas (<9 m²/g), Cu—Mn spinel oxide catalysts had comparable activity to that of a commercial Cu—Zn—Al catalyst for the production of H₂ via (combined) steam reforming of methanol.

Recent changes in the design and development of materials, such as polymer electrolyte membranes (e.g. aromatic polyethers containing pyridine units imbibed with H₃PO₄) and electrocatalysts (PCT/US2007/019711, WO/2008/03 8162, WO/2008/032228, PCT/US2007/019807, PCT/US2008/004479 and PCT/US2008/003758, each of which is herein incorporated by reference), allow the operation of PEMFCs at temperatures in the range of 130-210° C., whereas CO tolerance and functionality of the anode is highly improved, so that it can operate at about 180° C. with a reformate gas containing up to 2% CO. It should be noted that, in such a case, after treatment of exhaust gas is necessary to eliminate CO emissions.

The most popular direct methanol fuel cell (DMFC) technology is based on NAFION® polymer electrolytes. There are inherent problems in this approach stemming from the poor electrocatalytic activity of the Pt electrocatalysts (formation of CO intermediate that poisons Pt) and the high permeability of methanol through the NAFION® electrolyte (low open circuit voltage). This results into a significant decrease in cell efficiency rendering these cells applicable only in low power portable applications, where efficiency is not the main issue. A typical direct methanol fuel cell exhibits a power density of 50 mW/cm². Lower power densities are exhibited by direct ethanol fuel cells. Higher power densities can be obtained only under extremely severe conditions.

Reformed hydrogen fuel cells utilize hydrogen produced from hydrocarbons or alcohols via a fuel processor. In existing PEMFC systems, the fuel processor can occupy up to 40% of the system volume and accounts for 30% of the costs. Several attempts had been devoted in the past for the construction of compact integrated PEMFC reformers either by the introduction of reforming catalyst in the flow channels of the bipolar plate (S. R. Samms, R. F. Savinell, J. Power Sources 112 (2002) 13, herein incorporated by reference) or by the placement of small reformers in thermal contact with the stack (C. Pan, R. He, Q. Li, J. O. Jensen, N. J. Bjerrum, H. A. Hjulmand, A. B. Jensen, J. Power Sources 145 (2005) 392, herein incorporated by reference). However, separate reforming cells operating at higher temperatures than the fuel cell itself have been applied in order to achieve high reaction rates. A miniature in-situ H₂ generator (methanol fuel processor operating at 230° C.) integrated/attached with a high temperature (˜150-200° C.) membrane fuel cell is also being developed at Motorola Labs. Recently, a direct alcohol fuel cell using solid acid electrolyte and internal reforming catalyst has been reported (US2005/0271915, herein incorporated by reference). This fuel cell comprises an anode, a cathode, a solid acid electrolyte and an internal reformer positioned adjacent to the anode. Such an integrated configuration resulted in an increased power density and cell voltage relative to direct alcohol fuel cells not using an internal reformer. The electrolytes used in these fuel cells are of the solid acid type (e.g. CsH₂PO₄), which enable operation at high temperatures (200-350° C.) where the Cu—Zn—Al reforming catalysts are active. A similar configuration is also described in a provisional patent (US2002/0132145 herein incorporated by reference).

Currently, internal reforming is only available to high temperature fuel cells such as MCFC and SOFC. This is because the activity of the Ni based steam reforming catalysts is too low at the operating temperature of PEMFC and PAFC.

### SUMMARY

The present invention is related to the development of an Internal Reforming Alcohol Fuel Cell (IRAFC) where the alcohol reforming catalyst is incorporated into the anodic compartment of the fuel cell, so that primary fuel reforming takes place inside the fuel cell. The fuel cell comprises (i) a high temperature membrane electrode assembly (HT-MEA), able to operate at temperatures of about 190° C. to about 220° C. and (ii) a reforming catalyst, which can be either present together with the Pt-based electrocatalyst in the anode or deposited on the gas diffusion layer or deposited on the surface of monolithic structures.

The present invention allows for efficient heat management, since the “waste” heat produced by the fuel cell is in-situ utilized to drive the endothermic reforming reaction. The described fuel cell configuration is expected to be autothermal, highly efficient and with zero CO emissions.

These and other aspects of some exemplary embodiments will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments without departing from the spirit thereof. Additional features may be understood by referring to the accompanying drawings, which should be read in conjunction with the following detailed description and examples.

Accordingly, it is an object of the present invention to provide for an active reforming catalyst integrated into the anodic compartment, which operates at 190-220° C. and produces hydrogen in-situ by utilizing directly the waste heat of the electrochemical process to cover the energy demands of the endothermic reforming reaction.

It is yet another object of the present invention to provide for hydrogen which is readily oxidized on the anode electrocatalysts into protons with the high electrokinetic efficiency of a H₂ High Temperature PEM fuel cell.

It is still another object of the present invention to provide for the positive effect on the kinetics of the reforming reaction by depletion of hydrogen via its electrochemical pumping through the fuel cell membrane itself.

It is another object of the present invention to provide for minimal amounts of CO produced from the reforming catalytic bed, which nevertheless are not an issue for the anodic electrocatalyst due the high operating temperature of the cell.

It is another object of the present invention to provide for high-temperature polymer electrolytes, which are not permeable to methanol or ethanol with high thermal, mechanical and chemical stability.

It is another object of the present invention to provide for enhancement of the kinetic and electrokinetic efficiency of the high temperature system by the separate functions of the reforming catalyst and Pt electrocatalyst.

### BRIEF DESCRIPTION OF THE DRAWINGS

The following detailed description of the present invention will be better understood taking under consideration the accompanying drawings, where:

FIG. 1 is a schematic simplified view of an internal reforming alcohol fuel cell, so that layers that directly adjoin one another are shown as separate blocks for the sake of clarity and according to the present invention.

FIG. 2 is a graphical comparison of the polarization curves of the fuel cell prepared according to Comparative Example.

FIG. 3 is a graphical presentation of the transient response of the cell current, cell voltage and concentrations of detected gases under various operating conditions (open circuit and applying cell voltage of 500 mV) of the fuel cell prepared according to Comparative Example (Feed 2).

### DETAILED DESCRIPTION

The present invention pertains to an Internal Reforming Alcohol Fuel Cell (IRAFC) having a membrane electrode assembly (MEA) comprising a high-temperature proton-conducting electrolyte membrane sandwiched between the anodic (fuel reforming catalyst for the production of CO-free hydrogen+Pt-based/C) and cathodic Pt-based/C gas diffusion electrodes. Alcohol reforming catalyst is incorporated into the anodic compartment of the fuel cell, so that alcohol reforming takes place inside the fuel cell (Internal Reforming). In such a way the kinetic limitations and other problems associated with the use of direct alcohol fuel cells are avoided. Hydrogen can be catalytically produced from methanol or ethanol via endothermic steam reforming reaction.

The present invention allows for efficient heat management, since the “waste” heat produced by the fuel cell is in-situ utilized to drive the endothermic reforming reaction. The present invention allows the reforming reaction to be carried out at relatively low temperatures from about 190° C. to about 220° C., since there is a positive effect on the kinetics of the reforming reaction by depletion of hydrogen via its electrochemical pumping through the fuel cell membrane itself.

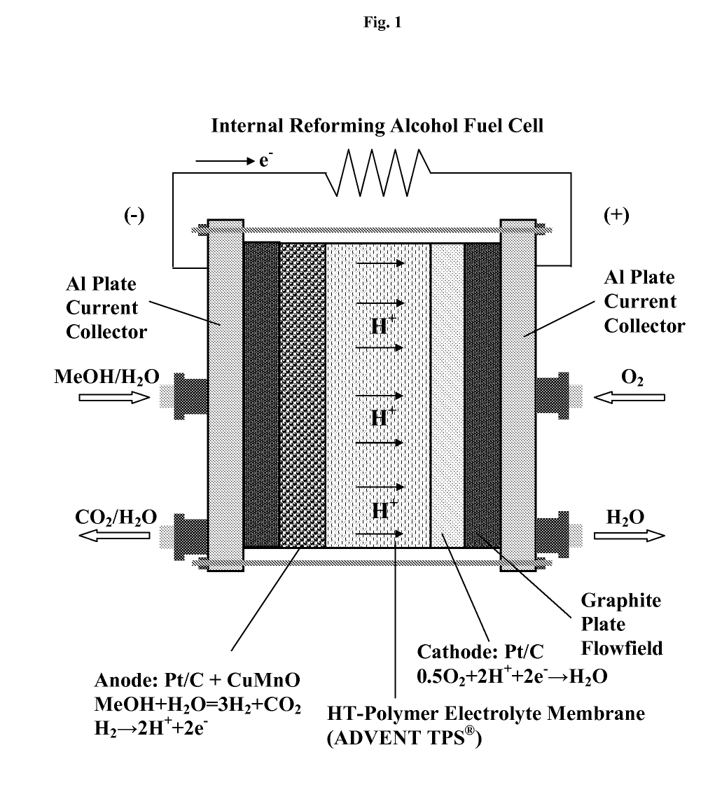

The present invention refers to such an Internal Reforming Alcohol Fuel Cell. As illustrated in FIG. 1, the fuel cell can comprise: A high temperature membrane electrode assembly (HT-MEA), able to operate at temperatures about 190° C. to about 220° C. This is based on the high temperature H₃PO₄-imbibed HT-MEAs selected from a wide group of MEAs (PCT/US2007/019711, WO/2008/038162, WO/2008/032228, PCT/US2007/019807, PCT/US2008/004479 and PCT/US2008/003758, each of which is herein incorporated by reference), which can operate for at least about 1000 hours or at about 200° C., an acceptable temperature for the alcohol reforming reactions. These particular polymer membrane systems can be used for this application since they combine good mechanical properties, high chemical, thermal and oxidative stability and high proton conductivity after doping with H₃PO₄. These polymers may be chosen from a wide family of polymers that are aromatic polyether bearing main and side chain pyridine groups. The aforementioned type of membranes operate with H₃PO₄ doping level even below about 150 wt %, while the PBI membrane can be imbibed with about 250 wt % phosphoric acid. This can be in favor of the life time of the reforming catalyst, with respect to the effect of H₃PO₄ poisoning on catalytic activity.

On the cathode side, the high-temperature ion-conducting electrolyte membrane directly adjoins an electronically conductive support, for example carbon powder or carbon black, or other conductive materials as are known to those of skill in the art, to the surface of which the electrocatalyst, for example Pt/C or Pt—Co/C, or other catalysts as are known to those of skill in the art, is dispersed. The electrocatalyst is responsible for cathodic reduction.

On the anode side, the high-temperature ion-conducting electrolyte membrane directly adjoins an electronically conductive support, for example carbon powder or carbon black, or other conductive materials as are known to those of skill in the art, to the surface of which the electrocatalyst, for example Pt/C or Pt—Ru/C, is dispersed. The electrocatalyst is responsible for anodic oxidation of hydrogen. The anode is directly adjoined with a fuel, for example methanol or other compounds or compositions as are known by those of skill in the art, reforming catalyst, by way of example not limitation, copper-manganese spinel oxides supported on copper foam, which will provide the required concentration of H₂, without the need of CO clean up, due to the high temperature operation.

A reforming catalyst, including by way of example not limitation copper-manganese spinel oxides; alternatively, other active reformer catalyst formulations can be employed, such as copper-based catalysts, i.e. Cu—ZnO—(Al₂O₃), Cu—Ce oxide mixtures, Cu—Zn—Al—Co, Cu—Zn—Al—Ce oxide mixtures, Cu—Zn—Al—Zr oxide mixtures, Cu—Zn—Mn oxide mixtures, Cu—Mn—Fe oxide mixtures, Cu—Mn—Al oxide mixtures and Cu—Mn—Ce oxide mixtures, or palladium-based catalysts, i.e. Pd—Ce—(Al) or Pd—Zn—(Al) oxide mixtures, which can be either (i) present together with the Pt-based electrocatalyst in the anode, (ii) deposited on the gas diffusion layer or (iii) deposited on the surface of monolithic structures (such as metallic (for example Cu, Al, etc.) foams). The reforming catalyst should be functional at the operating temperature of the fuel cell producing a CO-free reformate gas.

The reforming catalyst can be advantageously covered on the anode side by a carbon paste, which efficiently conducts the current out of the MEA to the current collector.

On the two outer ends the HT-MEA and the reformer catalyst are provided with current collectors such as carbon paper or other current collectors as are known by those of skill in the art. On the anode side the monolithic reforming catalytic structure operates as a current collector. Current collectors with porous structure, high electronic conductivity and low contact resistance in order to efficiently tap current and additionally distribute gases or liquids.

Current collectors on both sides are directly adjoined with bipolar plates (stainless steel or graphite or graphite composites) that surround the unit cell. These plates are responsible for efficient flow, current and heat distribution. Such bipolar plates can be stainless steel, graphite, graphite composites, or other materials having appropriate properties for efficient flow, current and heat distribution as are known to those of skill in the art.

Internal Reforming Alcohol Fuel Cell can be supplied with a methanol fuel, which can be mixed with water in appropriate ratios, which is catalytically steam reformed to a H₂-rich gas mixture, which together with air supplied on the cathode side drive the electrocatalytic operation of HT-MEA. The outlet stream of the fuel cell contains water and carbon dioxide. The H₂-rich gas mixture can also contain carbon dioxide and water.

The described fuel cell configuration does away with conventional fuel processors and allows for efficient heat management, since the “waste” heat produced by the fuel cell is in-situ utilized to drive the endothermic reforming reaction. The concepts of a catalytic reformer and of a fuel cell are combined in a single simplified autothermal direct alcohol (e.g. methanol or other alcohols as are known to those of skill in the art) High Temperature PEM fuel cell reactor. According to the configuration and the operating conditions described above the IRAFC is expected to be autothermal, highly efficient and with zero CO emissions.

The integration of the reforming catalyst in the anode compartment promotes its catalytic activity because it alleviates the inhibiting effect of hydrogen via its electrochemical pumping through the fuel cell membrane itself, thus inducing a promotional kinetic effect on the catalytic activity. A common kinetic aspect of methanol reforming catalysts is hydrogen inhibition on the reaction rate. The electrochemical interface of the aforementioned reforming catalysts with the electrolyte membrane can be active as well for the electrocatalytic reforming of methanol towards the production of CO₂ and H⁺. The dual function of the reforming catalyst both as conventional reforming catalyst and as electrocatalyst may be influenced by promotional catalytic effects.

The following comparative example illustrates the superior performance of the inventive internal reforming alcohol fuel cell. However, this example is presented for illustrative purposes only, and is not to be construed as limiting the invention to this example.

### Example 1

A 10 cm² internal reforming alcohol fuel cell was prepared according to the configuration described in FIG. 1. 6.5 g of Cu—Mn—O (atomic ratio Cu/(Cu+Mn)=0.30) spinel oxide supported on metallic copper foam was used as the reforming catalyst. 3 mg/cm² of ETEK Pt(30 wt %)/C was used as the anode electrocatalyst. A polymer with the following structure, was used as a polymer electrolyte (WO/2008/03 8162).

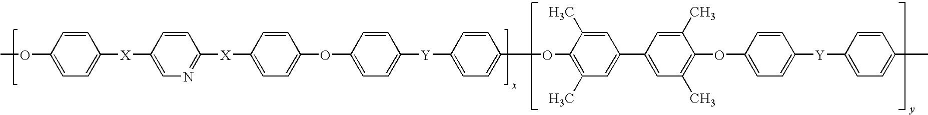

wherein in this formula each X is independently a chemical bond, optionally substituted alkylene, optionally substituted aromatic group, a hetero linkage (O, S or NH), carboxyl or sulfone;

each Y is the same or different and is sulfone, carbonyl or a phenyl phosphinoxide unit; and

x is a positive integer between 0.95-0.05

y is a positive integer between 0.05-0.95

3 mg/cm² Pt(30 wt %)/C was used as the cathode electrocatalyst. Vaporized methanol and water mixtures (H₂O/CH₃OH=1.5, helium as balance) were supplied to the anode compartment, where the reforming catalyst is directly adjoined with the anode electrode, according to FIG. 1. The total flow rate was 40 cm³/min (STP). Pure oxygen was supplied to the cathode compartment at a flow rate of 50 cm³/min (STP). The cell temperature was set at 200° C. The cell performance was evaluated under three different feedstreams:
Feed 1: 6.5% CH₃OH/9.75% H₂O/He
Feed 2: 13% CH₃OH/19.5% H₂O/He
Feed 3: 20% CH₃OH/30% H₂O/He

### Example 2

The GDL is prepared by wet proofing the carbon cloth (E-tek Weave=Plain; Weight=116 g/m2 (3.4 oz/yrd2); Thickness=0.35 mm; Width Limitation=75 cm) with a carbon/PTFE mixture. The mixture consists of 30% PTFE (60 wt % dispersion in water, Aldrich) and 70% carbon (80% Shawinigan Acetylene Black 20% Vulcan XC72R, Rawchem/Cabot) and the typical loading is 4 mg/cm². The GDL is then sintered up to 300° C.

The catalytic layer is then deposited onto the GDL. It consists of Pt catalyst (C-2 Catalyst: HP 30% Platinum on Vulcan XC-72R, E-TEK Division) and pyridine containing aromatic polyether polymer used as binder. The ratio of the components is 1:1 wt and the final electrode contains approx. 1 mg Pt/cm². The procedure is as following: first the polymer is dissolved in DMA and then the catalyst is added. The mixture is then stirred in a Silverson stirrer and sprayed onto the gas diffusion layer with an aerograph. The electrode is then sintered in a vacuum oven up to 190° C. for the removal of the solvent. Acid doped pyridine based polymer membranes is next used to prepare the membrane electrode assembly. For this, a die set up is used with fluorinated DuPont products (Teflon. FEP. PFA etc) and polyimide gaskets to achieve the appropriate compression and sealing in the single cell. Hot pressing conditions are 150-250° C. and 10 bar for 25 minutes.

### Example 3

6.5 g of Cu—Mn—O (atomic ratio Cu/(Cu+Mn)=0.30) spinel oxide supported on metallic copper foam was used as the reforming catalyst. The Cu metal foam (M-Pore) used in this example had a porosity of 20 ppi. From the parent foam sheet, cylindrical pieces of appropriate dimensions (10 cm²×1 cm thickness) were cut. The urea-nitrates combustion method was used for the synthesis of Cu—Mn spinel oxide foam reforming catalyst. Manganese nitrate [Mn(NO₃)₂.6H₂O], copper nitrate (Cu(NO₃)₂.3H₂O) and urea (CO(NH₂)₂) were mixed in the appropriate molar ratios (Cu/(Cu+Mn)=0.30, 75% excess of urea). The Cu metal foam was immersed in the aqueous solution of metal precursors and urea. Then, it was removed and excess of solution was blown out by hot air ejected from a heat gun maintained at 150° C. In that way, excess of water was removed and a uniform, thin gel film was formed onto the surface of foam. Rapidly, the temperature of heat gun was raised at 500° C. In few seconds, the combustion reaction started with evolution of a large quantity of gases and the oxide catalyst was formed on the surface of foam. This procedure was repeated several times in order to achieve the desired catalyst loading (6.5 g or 30% catalyst loading). The catalyst-coated foams were used as prepared and no additional oxidation or reduction pretreatment was carried out.

A methanol-water solution (molar ratio H₂O/CH₃OH=1.5) was fed via syringe pump through a stainless steel vaporizer (150° C.) and mixed with helium in the appropriate ratios prior entering the anode compartment. The following gas mixtures were supplied to the anode at a total flow rate of 40 cm³/min (STP):
Feed 1: 6.5% CH₃OH/9.75% H₂O/He
Feed 2: 13% CH₃OH/19.5% H₂O/He
Feed 3: 20% CH₃OH/30% H₂O/He
The cell temperature was set at 200° C.
The cell operated at atmospheric pressure.

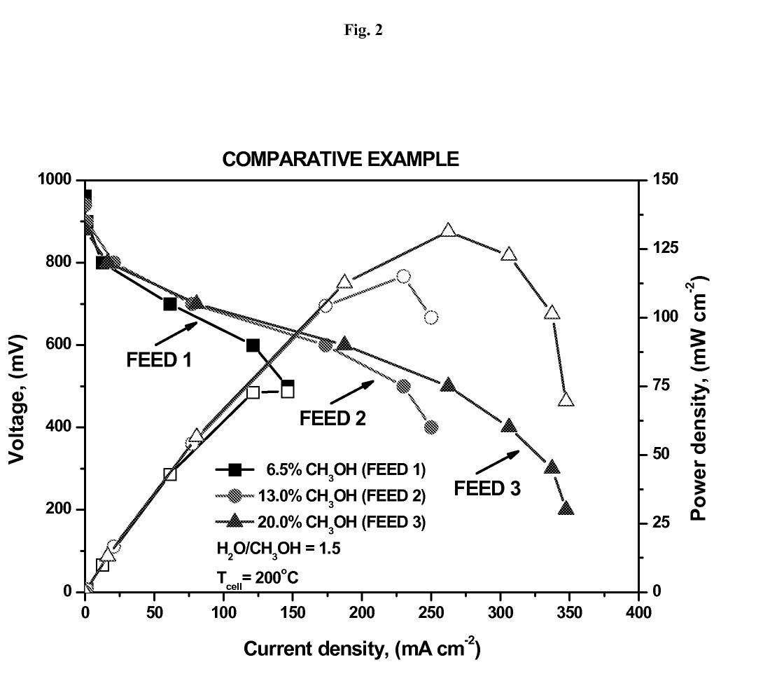

FIG. 2 shows the polarization curves of Comparative Example. As shown, the Internal Reforming Methanol High Temperature PEM Fuel Cell achieved peak power densities of 74 mW/cm² (FEED 1), 115 mW/cm² (FEED 2) and 131 mW/cm² (FEED 3). Increased methanol concentration caused significant cell performance improvement.

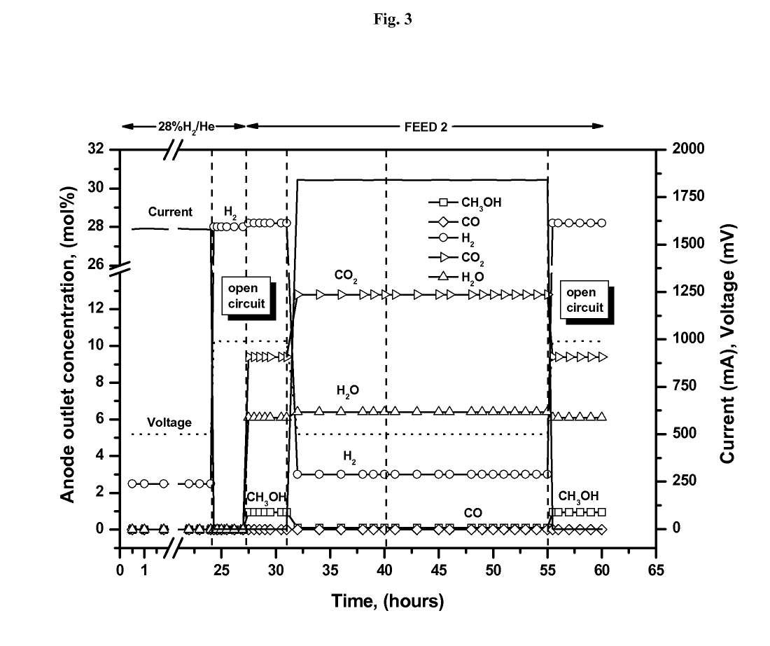

FIG. 3 shows the transient response of the cell current and concentrations of detected gases under various operating conditions (open circuit and applying cell voltage of 500 mV) of the fuel cell prepared according to Comparative Example (Feed 2). The open circuit potential of the cell was measured at 910-990 mV under various gas compositions conditions:
Anode gas: 28% H₂/He, Cathode gas: O₂
Anode gas: Feed 2, Cathode gas: O₂

In the case of 28% H₂/O₂ as anode and cathode gases, a voltage of 500 mV was applied to the cell and a maximum current of 1580 mA was obtained. When Feed 2 was supplied to the anode under open circuit conditions, 91% methanol conversion was obtained and 28% hydrogen was produced. Subsequently, a voltage of 500 mV was applied to the cell and a maximum current of 1840 mA was obtained, since reforming catalyst activity was enhanced, thus methanol conversion reached 100%, more hydrogen was produced and electro-oxidized by the anode electrocatalyst, resulting to increased cell performance (cell power density at 500 mV increased from 99 mW/cm² to 115 mW/cm²), as compared to the case of 28% H₂/O₂ as anode and cathode gases.

The foregoing description of some specific embodiments provides sufficient information that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. In the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference in their entirety. More generally, documents or references are cited in this text, either in a Reference List before the claims; or in the text itself; and, each of these documents or references (“herein-cited references”), as well as each document or reference cited in each of the herein-cited references (including any manufacturer specifications, instructions, etc.), is hereby expressly incorporated herein by reference.

What is claimed is:

1. A fuel cell comprising:
a high temperature membrane electrode assembly (HT-MEA), able to operate at temperatures of about 190° C. to about 220° C.;
a fuel reforming catalyst, which is incorporated into the anodic compartment of the HT-MEA

2. A fuel cell according to claim 1, wherein the HT-MEA comprises:
an anode consisting of Pt-based/C electrocatalyst;
a cathode consisting of Pt-based/C electrocatalyst;
a high-temperature polymer electrolyte membrane consisting of a polymer electrolyte of the following structure: 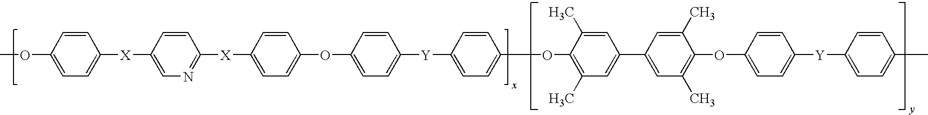
wherein in this formula each X is independently a chemical bond, optionally substituted alkylene, optionally substituted aromatic group, a hetero linkage (O, S or NH), carboxyl or sulfone;
each Y is the same or different and is sulfone, carbonyl or a phenyl phosphinoxide unit; and
x is a positive integer between 0.95-0.05
y is a positive integer between 0.05-0.95
and any other polymer electrolyte that can operate at temperatures between about 180° C. to about 230° C.

3. A fuel cell according to claim 1, wherein the fuel reforming catalyst is:
mixed with the electrocatalyst in the electrocatalytic layer of the anode electrode;
deposited on the gas diffusion layer;
being part of the gas diffusion layer;
deposited on the surface of monolithic structures.

4. A fuel cell according to claim 1, wherein the fuel reforming catalyst is selected from the group consisting of Cu—Mn oxide mixtures, Cu—Zn—Al oxide mixtures, Cu—Ce oxide mixtures, Cu—Zn—Al—Co, Cu—Zn—Al—Ce oxide mixtures, Cu—Zn—Al—Zr oxide mixtures, Cu—Zn—Mn oxide mixtures, Cu—Mn—Fe oxide mixtures, Cu—Mn—Al oxide mixtures, Cu—Mn—Ce oxide mixtures, Pd—Ce—(Al) oxide mixtures and Pd—Zn—(Al) oxide mixtures.

5. A method of operating a fuel cell comprising:
providing an anode;
providing a cathode;
providing a high-temperature polymer electrolyte membrane;
providing a fuel reforming catalyst, which is incorporated into the anodic compartment;
providing a fuel;
operating the fuel cell at a temperature ranging from about 180° C. to about 230° C.

6. A method according to claim 5, wherein the fuel is an alcohol.

7. A method according to claim 5, wherein the fuel is selected from the group consisting of methanol, ethanol, propanol, methyl formate and dimethyl ether.

8. A method according to claim 5, wherein the fuel cell is operated at a temperature ranging from about 180° C. to about 230° C.

9. A method according to claim 5, wherein the fuel reforming catalyst is selected from the group consisting of Cu—Mn oxide mixtures, Cu—Zn—Al oxide mixtures, Cu—Ce oxide mixtures, Cu—Zn—Al—Co, Cu—Zn—Al—Ce oxide mixtures, Cu—Zn—Al—Zr oxide mixtures, Cu—Zn—Mn oxide mixtures, Cu—Mn—Fe oxide mixtures, Cu—Mn—Al oxide mixtures, Cu—Mn—Ce oxide mixtures, Pd—Ce—(Al) oxide mixtures and Pd—Zn—(Al) oxide mixtures.

10. A method according to claims 5 and 9, wherein the fuel reforming catalyst is deposited on the surface of monolithic structures selected from the group of metallic foams and metallic honeycombs.

11. A method according to claims 5, 9 and 10, wherein the monolithic reforming catalyst operates as a current collector.

12. A method according to claims 5, 9 and 10, wherein the monolithic reforming catalyst operates as a gas distributor.

13. A method according to claims 5, 9 and 10, wherein the monolithic reforming catalyst operates as a heat distributor.

14. A method according to claim 5 and 9 where the reforming catalyst is placed in the gas diffusion layer.

15. A claim according to claims 5 and 9 where the reforming catalyst is placed in the catalytic layer so that it can function as electrocatalyst for the electrooxidation of methanol and alcohol.

16. A method according to claim 5, wherein the high-temperature polymer electrolyte membrane comprises polymers of the following structure: 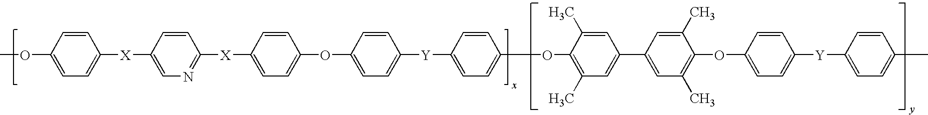
wherein in this formula each X is independently a chemical bond, optionally substituted alkylene, optionally substituted aromatic group, a hetero linkage (O, S or NH), carboxyl or sulfone;
each Y is the same or different and is sulfone, carbonyl or a phenyl phosphinoxide unit; and
x is a positive integer between 0.95-0.05
y is a positive integer between 0.05-0.95
and any other polymer electrolyte that can operate at temperatures between about 180° C. to about 230° C.

17. A method according to claim 5, comprising fluorinated DuPont products (Teflon. FEP. PFA etc), polyimide gaskets to achieve the appropriate compression and sealing in the single cell, wherein hot pressing conditions are about 150° C. to about 250° C. and 10 bar for 25 minutes.

18. A method according to claim 5, wherein the inhibiting effect of hydrogen on the reforming reaction rate is alleviated via its electrochemical pumping through the fuel cell membrane itself.

19. A method according to claim 5, wherein the heat produced by the fuel cell is in-situ utilized to drive the endothermic reforming reaction.
